(19) United States
(12) Patent Application Publication
(10) Pub. No.: US 2018/0281727 A1
(43) Pub. Date: Oct. 4, 2018

(54) MOTOR VEHICLE WITH SAFETY BELT RESTRAINT SYSTEM

(71) Applicant: GM GLOBAL TECHNOLOGY OPERATIONS LLC, Detroit, MI (US)

(72) Inventor: Thomas Jenny, Alsbach-Haehnlein (DE)

(73) Assignee: GM GLOBAL TECHNOLOGY OPERATIONS LLC, Detroit, MI (US)

(21) Appl. No.: 15/945,451

(22) Filed: Apr. 4, 2018

(30) Foreign Application Priority Data
Apr. 4, 2017 (DE) 102017003291.2

(51) Int. Cl. B60R 21/18; B60R 22/02; B60R 22/28; B60R 21/264; B60R 21/231

(52) U.S. Cl. CPC B60R 21/18; B60R 22/023; B60R 21/231; B60R 21/264; B60R 22/28

(57) ABSTRACT

A safety belt restraint system for a seat, particularly a rear seat, of a motor vehicle includes a safety belt for the seat, a belt buckle configured to releasably fix the safety belt to the motor vehicle, a fastening element attached to the safety belt for separably latching in the belt buckle, and an airbag integrated into the safety belt. The airbag include a first section for the abdomen and the chest and a second section of the airbag for the head.

### CROSS-REFERENCE TO RELATED APPLICATION

This application claims priority to German Patent Application No. 102017003291.2, filed Apr. 4, 2017, which is incorporated herein by reference in its entirety.

### TECHNICAL FIELD

The present disclosure pertains to a safety belt restraint system and a motor vehicle.

### BACKGROUND

Safety belt restraint systems are used in motor vehicles in order to reduce the risk of injuries to the occupant or occupants during an accident. The safety belts are intended to restrain the occupant of a motor vehicle in the vehicle seat during high decelerations as might occur during a frontal impact due to a collision with other motor vehicles or objects. Restraint system of this type makes it possible to prevent injuries to the occupants, which are caused by the occupants being ejected from the motor vehicle or striking components of the vehicle. It is furthermore known to integrate an airbag for the abdomen and the chest into the safety belt such that additional protection for the occupants is provided in the form of a deployed airbag, which is integrated into the safety belt. US 2009/0278339 A1 discloses a safety belt restraint system with a safety belt having an airbag installed or integrated into the safety belt.

### SUMMARY

The present disclosure provides a safety belt restraint system and a motor vehicle with a safety belt restraint system with which a vehicle occupant's head can also be protected during an accident with the aid of the airbag integrated into the safety belt.

In an embodiment, a safety belt restraint system for a seat, particularly a rear seat, of a motor vehicle is provided, which includes a safety belt configured to be fixed on the motor vehicle. A fastening element, particularly a fastening latch, is fixed on the safety belt for being separably fastened in the belt buckle. An airbag with a body section configured for the torso (e.g., abdomen and chest) of a seated occupant and a head section configured for the head of the seated occupant is integrated into the safety belt. After the first section of the airbag for the body has been deployed, the second section of the airbag for the head provides additional effective protection for the head of the occupant during an accident. This makes it possible, for example, to prevent the head from turning during an accident or to prevent the head from striking components of the motor vehicle located in front of the head due to the arrangement of a section of the airbag between the head of the occupant and front components of the motor vehicle, for example a front seat if the safety belt restraint system is arranged on a rear seat. In this way, the safety and the accident protection of occupants can be additionally improved.

The section of the airbag for the head is particularly configured in such a way that, after the deployment, the dimension of the section of the deployed airbag in the Y-direction is greater than 25 cm, 30 cm or 35 cm. A sufficiently large dimension of the section of the airbag for the head in the Y-direction or transverse direction of the safety belt restraint system or the motor vehicle makes it possible to provide a high level of protection during an accident and to thereby effectively block the head from turning during the accident.

In another embodiment, the section of the airbag for the head is configured in such a way that, after the deployment, a depression for accommodating the head is formed on the side of the section of the deployed airbag, which faces the head. The depression advantageously makes it possible to positively hold the head in the depression during an accident when the head is arranged in the depression such that the airbag positively prevents the head from turning during the accident. The depression is preferably greater than 3 cm, 5 cm, 10 cm, 15 cm or 20 cm when the airbag is completely deployed.

In an embodiment, the section of the airbag for the head is configured in such a way that, after the complete deployment of the section for the head, an upper end of the deployed section of the airbag for the head essentially reaches an upper end of a headrest on the seat equipped with the safety belt restraint system in the Z-direction. In this context, “essentially” means that the upper end of the completely deployed section of the airbag for the head is preferably spaced apart from the upper end of the headrest in the Z-direction by less than 30 cm, 20 cm, 10 cm or 5 cm. This makes it possible to ensure that the head is soundly and effectively secured during an accident.

The airbag with the sections for the stomach or abdomen, the chest and the head is preferably realized in one piece. In another embodiment, the airbag with the sections for the stomach or abdomen, the chest and the head is composed of multiple pieces and this multi-piece airbag is also regarded as an airbag with sections for the abdomen, the chest and the head.

In a variation, the airbag is configured in such a way that, after the deployment of the airbag, a partition wall of the airbag with a passage opening for a gas for deploying the airbag is respectively arranged between the section for the abdomen and the chest and/or between the section for the chest and the head. A design with partition walls is regarded as a one-piece design of the airbag. The airbag is preferably composed of multiple parts such that no partition walls exist between the section for the abdomen and the chest and/or between the section between the head and the chest, but rather outer walls that are in contact with the surroundings or the ambient air.

The section of the airbag for the head is preferably configured in such a way that, after the deployment of the section for the head, the maximum dimension of the deployed section for the head in the Y-direction is 1.2-times, 1.5-times, 2-times, 2.5-times or 3-times greater than the maximum dimension of the deployed section for the chest and/or the abdomen in the Y-direction. In other words, the head section is configured to have a dimension in the Y-direction that is 20%, 50%, 100%. 150% or 200% greater than the maximum dimension of the body in the Y-direction when the airbag is in the deployed state. The section for the head requires a much greater dimension in the Y-direction than the section of the airbag for the chest and/or abdomen because the head is most vulnerable during an accident and no safety belt is provided on the head. In this way, a sound restraint of the head during an accident can be achieved with the section of the airbag for the head.

In an embodiment, the section of the airbag for the abdomen and/or the chest is configured in such a way that, after the deployment of the section for the abdomen and/the chest, the deployed section of the airbag for the abdomen and/or the chest has an essentially tubular shape. The design of the section for the abdomen and/or the chest in the form of an essentially tubular section is sufficient for correspondingly protecting the occupant on the chest and on the abdomen.

In an embodiment, the section of the airbag for the abdomen and/or the chest is configured in such a way that, after the deployment of the section for the abdomen and/the chest, the deployed section of the airbag for the abdomen and/or the chest is essentially V-shaped and/or has an essentially oval or elliptical cross section.

The section of the airbag for the head is particularly configured in such a way that, after the deployment of the section for the head, the deployed section for the head is essentially U-shaped or V-shaped in a horizontal section. An essentially U-shaped or V-shaped design of the section for the head makes it possible to form a depression on the section of the airbag for the head or to only form a depression when a head impacts on the section of the airbag of the head. This U-shaped or V-shaped design of the deployed section of the airbag for the head makes it possible to soundly protect the head from components of the motor vehicle during an accident and to furthermore prevent the head from turning by holding the head on the section of the airbag for the head.

In an embodiment, the section of the airbag for the head is completely integrated into the safety belt on the side facing the occupant such that, after the deployment of the section for the head, the deployed section of airbag for the head is at least partially arranged between the safety belt and the head or the section of the airbag for the head is completely integrated into the safety belt on the side facing away from the occupant such that, after the deployment of the section for the head, the deployed section of the airbag for the head is at least partially, in particular completely, arranged in front of the safety belt. If the safety belt restraint system is configured for a rear seat, the section of the airbag for the head is completely integrated into the safety belt on the side facing away from the occupant such that the section of the airbag for the head is during an accident arranged between a front component of the motor vehicle and the safety belt or the head. In this way, the head is prevented from contacting components of the motor vehicle during the accident.

In a variation, the section of the airbag for the chest is completely integrated into the safety belt on the side facing the occupant such that, after the deployment of the section for the chest, the deployed section of the airbag for the chest is at least partially arranged between the safety belt and the chest or the section of the airbag for the chest is completely integrated into the safety belt on the side facing away from the occupant such that, after the deployment of the section for the chest, the deployed section of the airbag for the chest is at least partially, in particular completely, arranged in front of the safety belt.

In a variation, the section of the airbag for the abdomen is completely integrated into the safety belt on the side facing the occupant such that, after the deployment of the section for the abdomen, the deployed section of the airbag for the abdomen is at least partially arranged between the safety belt and the abdomen or the section of the airbag for the abdomen is completely integrated into the safety belt on the side facing away from the occupant such that, after the deployment of the section for the abdomen, the deployed section of the airbag for the abdomen is at least partially, in particular completely, arranged in front of the safety belt. The arrangement of the section for the abdomen and/or the chest on the side of the safety belt facing the occupant has the advantage that the occupant is not in direct contact with the safety belt, but rather with the section of the airbag for the chest and/or the abdomen, such that significant surface pressures, i.e. pressures per unit of area, between the occupant and the safety belt can be prevented because the section of the airbag for the abdomen and/or the chest has a greater contact surface on the occupant than the safety belt.

In an embodiment, a gas line is integrated into the safety belt and/or the fastening element and/or the belt buckle and/or the belt retractor in order to convey gas from a gas generator into the airbag through the gas line.

In an embodiment, the safety belt restraint system features a safety belt with three-point mounting such that the safety belt includes a shoulder belt and a lap belt.

In an embodiment, an outlet opening for discharging gas is formed on the airbag, particularly in the section for the head and/or the section for the chest and/or the section for the abdomen. The outlet opening enables the airbag to become soft after its deployment and furthermore makes it possible to slowly decrease the volume of the airbag after the accident or after its complete deployment due to the discharge of gas from the airbag into the surroundings.

In a variation, the section of the airbag for the head is configured in such a way that, after the deployment of the section for the head, the section of the airbag for the head is additionally fastened on the safety belt, particularly a shoulder belt of the safety belt, with a fastening strap.

In an embodiment, the airbag, particularly the outer wall of the airbag, is made of an identical material or of different materials. The airbag, particularly the outer wall of the airbag, is preferably made of PA or PET.

In an embodiment, the airbag, particularly the outer wall of the airbag, is at least partially, in particular completely, made of an elastic and/or plastic material. The elastic and/or plastic material expands during the deployment of the airbag due to the force of pressure acting upon the airbag, particularly the outer wall of the airbag, such that the completely deployed airbag has a larger volume than an airbag, the material of which does not expand. A smaller volume or a smaller surface area of the safety belt is therefore required for accommodating the undeployed airbag being integrated into the safety belt.

The safety belt restraint system preferably includes a belt retractor and/or a gas generator and/or a gas line.

The airbag is preferably integrated into the safety belt by integrally and/or positively fixing the airbag on the safety belt, particularly with an adhesive connection and/or a sewn connection and/or a riveted connection. In an embodiment, the airbag is integrated into the safety belt by arranging the airbag between two sections of the safety belt. Two sections of the safety belt are preferably connected to one another, particularly with a sewn connection, such that a pocket is formed between the two sections and the safety belt is arranged in the pocket, wherein the two sections of the safety belt preferably have essentially the same width and consist of separate sections that, however, are connected to one another. In a variation, the two sections of the safety belt are formed of a one-piece safety belt by folding two sections of the safety belt on top of one another such that a pocket is formed between the two sections, wherein the end regions of the sections are connected to one another, particularly with a sewn connection.

In an embodiment, a linear predetermined breaking point is formed on the safety belt such that the connection can be purposefully separated along the predetermined breaking point due to the deployment of the airbag in order to thereby form a linear opening for the airbag being deployed. The predetermined breaking point makes it possible to form a linear opening on the pocket such that the airbag can deploy through this opening. If the linear predetermined breaking point is formed on the side of the safety belt facing the occupant, the airbag is integrated into the safety belt on the side facing the occupant. If the linear predetermined breaking point is formed on the side of the safety belt facing away from the occupant, the airbag is integrated into the safety belt on the side facing away from the occupant. The linear predetermined breaking point is preferably realized in the form of a sewn connection. The airbag being deployed causes a thread on the sewn connection to tear or otherwise release. The airbag integrated into the safety belt is preferably folded together.

In an embodiment, the gas line is installed or integrated into the belt retractor and/or into the safety belt and/or into the fastening element and/or into the belt buckle. If the gas line is installed into the fastening element and the belt buckle, the gas line on the fastening element can be temporarily connected to the gas line in the belt buckle in a fluid-conducting fashion with a coupling device, while the fastening element is mechanically fixed in the belt buckle. To this end, coupling devices are respectively formed on the end of the gas line of the fastening element and on the end of the gas line of the belt buckle. In order to convey the gas from the gas line on the fastening element to the gas line in the belt buckle and/or into the airbag, the fastening element either is rigidly connected to the safety belt or, if the safety belt is movably arranged on the fastening element, a pneumatic transfer mechanism makes it possible to convey gas from the gas line in the fastening element to the gas line in the safety belt and/or into the airbag.

A deflection device for the safety belt is preferably fixed on the fastening element.

A motor vehicle having a vehicle body, a drive engine, particularly an internal combustion engine and/or an electric motor, at least one seat with a seat section and a back section and a safety belt restraint system for the seat, wherein the safety belt restraint system is realized in the form of a safety belt restraint system described in this patent application.

### BRIEF DESCRIPTION OF THE DRAWINGS

The present disclosure will hereinafter be described in conjunction with the following drawing figures, wherein like numerals denote like elements.

FIG. 1 shows a side view of a motor vehicle;

FIG. 2 shows a perspective view of a safety belt restraint system with a safety belt for a seat of the motor vehicle;

FIG. 3 shows a front view of an occupant and the safety belt restraint system with deployed airbag, wherein the airbag is completely integrated into the safety belt on the side facing away from the occupant;

FIG. 4 shows a side view of the occupant and the safety belt restraint system according to FIG. 3, as well as the seat;

FIG. 5 shows a longitudinal section through the safety belt, a highly simplified occupant and a deployed airbag, wherein the airbag is completely integrated into the safety belt on the side facing the occupant;

FIG. 6 shows a front view of the occupant and the safety belt restraint system with the deployed airbag, wherein the airbag is completely integrated into the side of the safety belt facing the occupant;

FIG. 7 shows a side view of the occupant and the safety belt restraint system according to FIG. 6, as well as the seat;

FIG. 8 shows a section of the airbag for the head according to a first exemplary embodiment in the form of a section along the line A-A in FIG. 6;

FIG. 9 shows a section of the airbag for the head according to a second exemplary embodiment in the form of a section along the line A-A in FIG. 6;

FIG. 10 shows a front view of the occupant and the safety belt restraint system with deployed airbag, wherein the airbag is partially integrated into the safety belt on the side facing the occupant and partially integrated into the safety belt on the side facing away from the occupant; and

FIG. 11 shows a side view of the occupant and the safety belt restraint system according to FIG. 10, as well as the seat.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

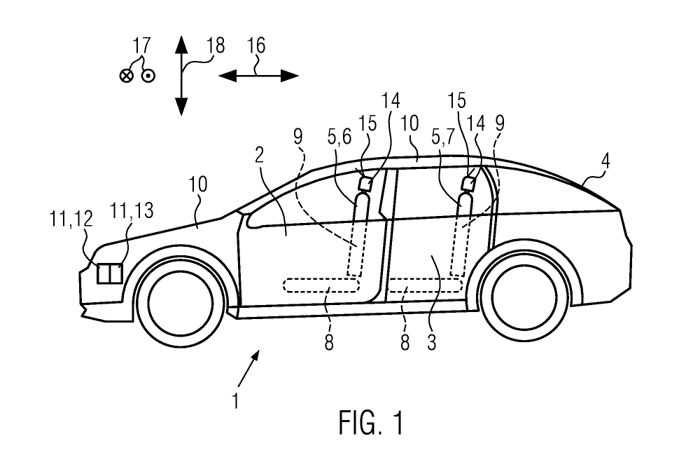

FIG. 1 shows a motor vehicle 1 with a drive engine 11, for example an internal combustion engine 12 and/or an electric motor 13, and a vehicle body 10. The motor vehicle 1 has an X-direction or longitudinal direction 16, a Y-direction or lateral direction 17 and a Z-direction or vertical direction 18. The vehicle body 10 defines an interior with two seats 5 in the form of front seats 6 and three seats 5 in the form of rear seats 7. The term rear seats 7 generally refers to seats 5 that are arranged behind a front seat 6, i.e. seats 5 that are located, for example, in a second or third row behind the front seats 6. A front door 2 serves for entering and exiting the motor vehicle at the front seats 6 and a rear door 3 serves for entering and exiting the motor vehicle at the rear seats 7. A hatch 4 is formed on the rear side of the motor vehicle 1. The seats 5 respectively include a seat section 8 and a back section 9 with a seat cover, padding and a support structure. A headrest 14 is respectively fixed on the seat sections 8. The headrest 14 has an upper end 15 referred to the Z-direction. The three rear seats 7 are combined into a bench seat and the back section 9 of the three rear seats 7 is divided into two parts in a ratio of 1/3 to 2/3, i.e. a larger part serves as back section 9 for two rear seats 7 and a smaller part serves as back section 9 for one rear seat 7.

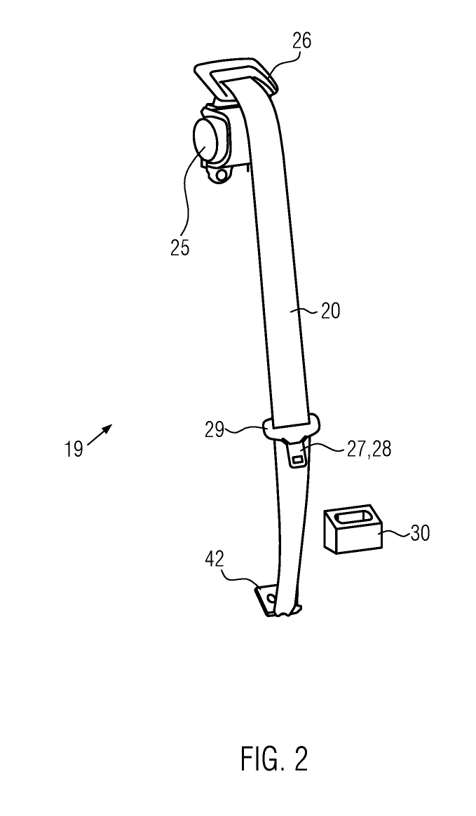

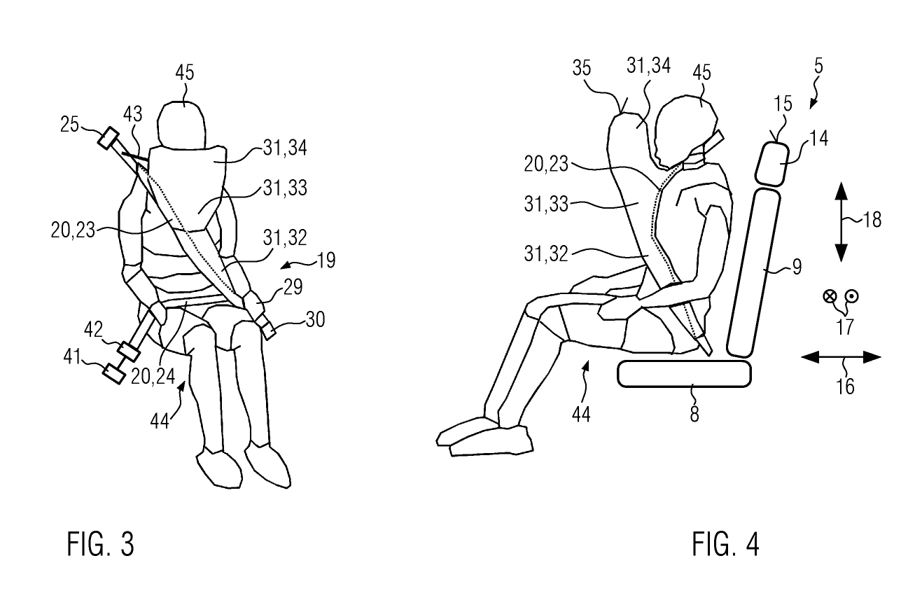

FIGS. 3 and 4 show a first embodiment of a safety belt restraint system 19 for a seat 5, particularly a rear seat 7. A first end of a safety belt 20 is fixed on the vehicle body 2 in a stationary fashion by means of a fixing device 42. The other, second end of the safety belt 20 is fixed on a belt retractor 25. The belt retractor 25 features a roller and a torsion spring, as well as a cover 26 with a slot for guiding through the safety belt 20. An end region on the second end of the safety belt 20 is wound up on the roller such that the safety belt 20 can be adapted to different sizes of occupants on the seat 5. A deflection device 29 (FIG. 2) features a slot, through which the safety belt 20 is guided, and a fastening elements 27 in the form of a fastening latch 28 for being temporarily interlocked with the belt buckle 30. The belt buckle 30 and the belt retractor 25 are directly or indirectly fixed on the vehicle body 10 of the motor vehicle 1.

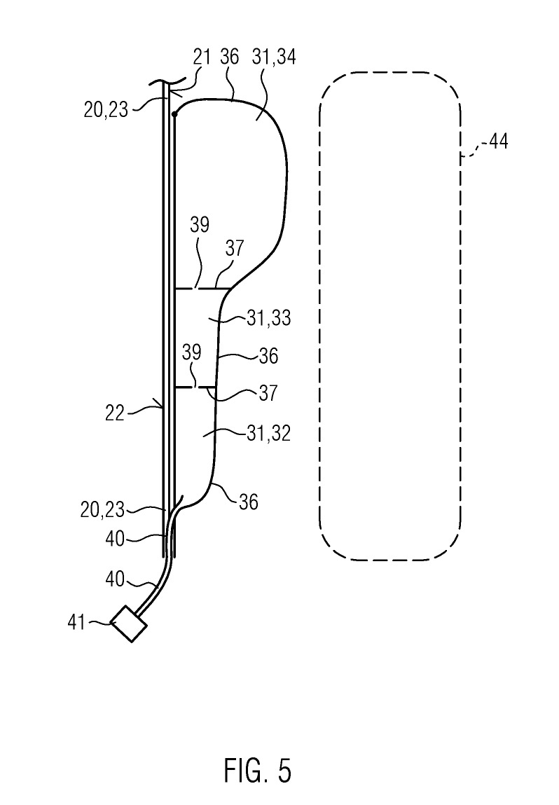

The safety belt 20 has a side 21 that faces the occupant 44 and a side 22 that faces away from the occupant 44. The safety belt 20 has a three-point mounting, which is formed by the belt retractor 25, the deflection device 29 on the belt buckle 30 and the fixing device 42. The safety belt 20 is therefore fictitiously divided into a shoulder belt 23 and a lap belt 24. An airbag 31 is respectively integrated into or fixed on the safety belt 20 on the side 22 facing away from the occupant (FIGS. 3 and 4). The airbag 31 includes a section 32 for the stomach or abdomen, a section 33 for the chest and a section 34 for the head 45 of the occupant 44. Referred to the vertical direction, the section 34 is arranged on the top, the section 33 is arranged in the middle and the section 32 is arranged on the bottom. The airbag 31 with the sections 32, 33 and 34 is realized in one piece and the individual sections 32, 33, 34 are separated from one another by a partition wall 37 (FIG. 5). The airbag 31 also has an outer wall 36, which on one side is in contact with the surroundings or the ambient air when the airbag 31 is deployed, and an inner side, which defines an interior of the airbag 31. The partition walls 37 feature a passage opening 39 for gas. Furthermore, a gas line 40 is integrated into a section of the safety belt 20 between the end of the section 32 for the abdomen and the fixing device 42 (FIG. 5). The gas line 40 leads to a gas generator 41 such that, when the motor vehicle 1 is involved in an accident, gas from the gas generator 41 can be introduced into the section 32 through the gas line 40 and then flow from the section 32 into the sections 33, 34 of the airbag 31 through the openings 39.

The motor vehicle 1 also features sensors for detecting an accident or an imminent accident and the gas generator 41 is activated by a control and/or regulating unit if an accident is imminent or has already occurred. Since the entire airbag 31 is respectively integrated into or fixed on the safety belt 20 on the side 22 of the safety belt 20 facing away from the occupant prior to the deployment of the airbag 31, the airbag 31 essentially is completely arranged in front of the safety belt 20, particularly in front of the shoulder belt 23, after the airbag 31 has been deployed. This is particularly advantageous if the safety belt restraint system is arranged on a rear seat 7 because the airbag 31 prevents the occupant 44 from striking components of the motor vehicle 1 located in front of the occupant 44, particularly front seats 6, and the accident risk for the occupant 44 is thereby reduced. When the airbag 31 is deployed, there is essentially no clearance between an upper end 35 of the section 34 of the airbag 31 for the head 45 and the upper end 15 of the headrest 14 in the Z-direction. This means that the upper end 35 of the section 34 of the airbag 31 is essentially aligned identical to the upper end 15 of the headrest 14 of the motor vehicle 1 in the vertical direction 18. In this way, the head 45 of the occupant 44 can be protected in a particularly effective fashion when the motor vehicle 1 is involved in an accident.

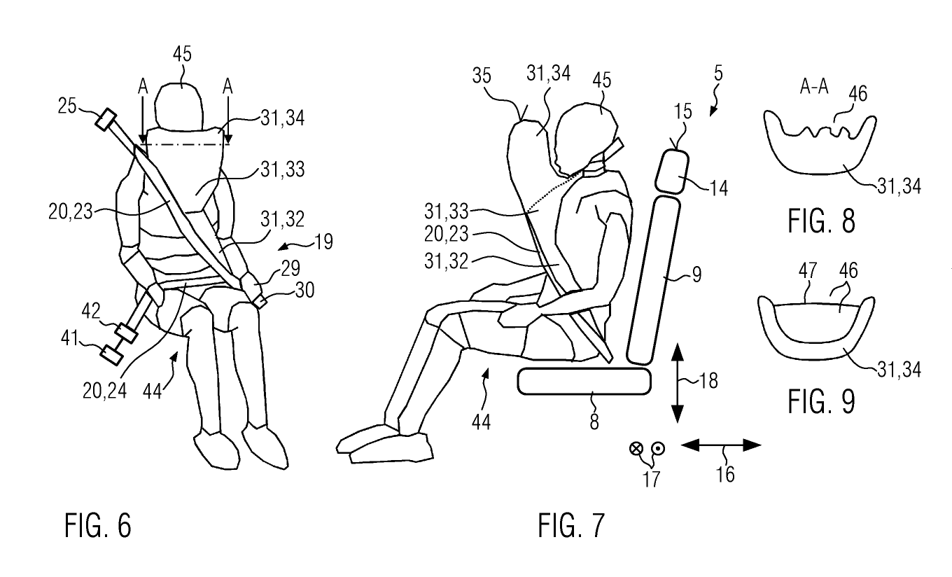

FIGS. 5-7 show a second embodiment of the safety belt restraint system 19. In essence, only the differences between this second exemplary embodiment and the first exemplary embodiment according to FIGS. 3 and 4 are described below. Prior to the deployment of the airbag 31, the airbag 31 is completely integrated into the safety belt 20 on the side 21 of the safety belt 20 facing the occupant 44. After the deployment of the airbag 31, the airbag 31 is therefore partially arranged between the safety belt 20 and the occupant 44. In a section A-A according to FIG. 6, in which the plane of section extends horizontally, the section 34 of the airbag 31 for the head 45 is essentially configured in a U-shaped fashion. FIG. 8 shows a first variation of the U-shaped design of the section 34 and FIG. 9 shows a second variation of the section 34. In the first variation illustrated in FIG. 8, a depression 46 with a depth or size of approximately 10 cm is therefore formed on the side of the section 34 facing the occupant 44 in order to accommodate the head 45 of the occupant 44. This depression therefore makes it possible to hold the head 45 on the section 34 during the accident, particularly in a positive fashion, such that the head 45 is blocked from turning during the accident. In the second variation illustrated in FIG. 9, a planar structure 47, particularly a fabric or a film, is fixed on the end regions of the U-shaped section 34. The depression 46 is therefore formed in front of the planar structure 47 and behind the planar structure 47. The planar structure 47 enables the end regions of the section 34 to move toward the head 45 after the head 45 has struck the planar structure 47 and to thereby non-positively rest against the head 45 with an additionally increased force of pressure such that the head 45 is non-positively fixed on the section 34 during the accident.

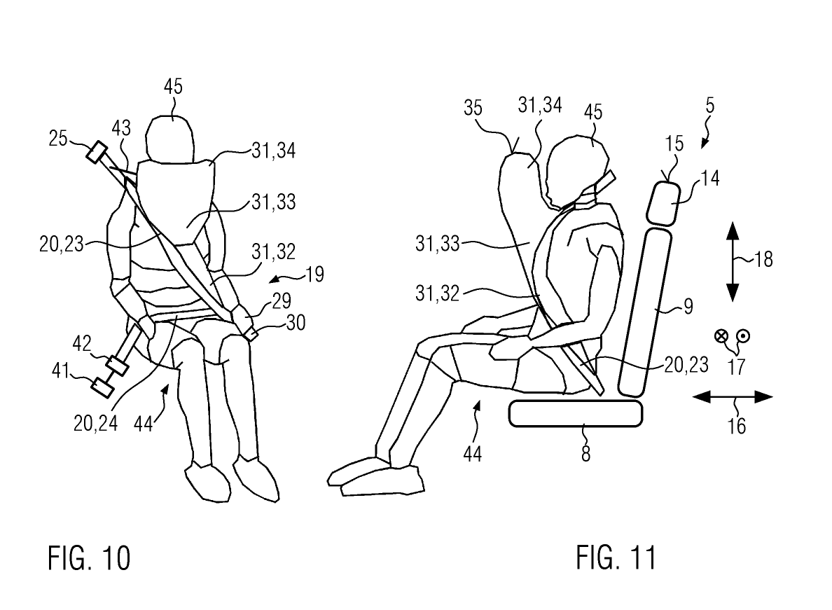

FIGS. 10 and 11 show a third exemplary embodiment of the safety belt restraint system 19. In essence, only the differences between this third exemplary embodiment and the first and second exemplary embodiments are described below. The section 34 of the airbag 31 for the head 45 is fixed on the side 22 of the safety belt 20 facing away from the occupant and the sections 32 and 33 are respectively fastened or fixed on the side 21 of the safety belt 20 facing the occupant. A fastening strap 43 is connected to the safety belt 20 on an upper end region of the section 34 of the airbag 31 such that the fastening strap 43 allows an additional alignment of the section 34 relative to the safety belt 20. The fastening strap 43 is also provided in the first exemplary embodiment according to FIG. 3.

All in all, the safety belt restraint system 19 and the motor vehicle 1 are associated with significant advantages. The integration of the section 34 of the airbag 31 for the head 45 into the safety belt 20 makes it possible to ensure an additional effective protection for the head 45 of the occupant 44 when the motor vehicle 1 is involved in an accident. During the accident, the section 34 particularly prevents a twisting motion of the head 45 and the direct contact of the head 45 with components located in front of the occupant 44, particularly a front seat 6 if the safety belt restraint system 19 is arranged on a rear seat 7.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment as contemplated herein. It should be understood that various changes may be made in the function and arrangement of elements described in an exemplary embodiment without departing from the scope of the invention as set forth in the appended claims.

1-15. (canceled)

16. A safety belt restraint system for a seated occupant of a motor vehicle comprising:
a safety belt for a seat supported in the motor vehicle;
a belt buckle configured to be fixed on the motor vehicle;
a fastening element coupled to the safety belt and operable to releasably latch the safety belt to the belt buckle; and
an airbag having a body section configured for a torso of the seated occupant and a head section airbag configured for a head of the seated occupant, wherein the airbag is integrated into the safety belt in a folded state and expandable into a deployed state out of the safety belt.

17. The safety belt restraint system according to claim 16, wherein the body section of the airbag comprises a abdomen region configured to an abdomen of the seated occupant and a chest region configured for a chest of the seated occupant, wherein the chest region is interposed between the abdomen region and the head section when the airbag is in the deployed state.

18. The safety belt restraint system according to claim 16, wherein the head section of the airbag is configured to have a dimension in the Y-direction greater than 25 cm in the deployed state.

19. The safety belt restraint system according to claim 16, wherein the head section of the airbag is configured to form a depression on a side of the head section facing the seated occupant in the deployed state.

20. The safety belt restraint system according to claim 16, wherein the head section of the airbag is configured to extend in the Z-direction to an upper end of a headrest on the seat equipped with the safety belt restraint system in the deployed state.

21. The safety belt restraint system according to claim 16, wherein the airbag comprises a one piece component.

22. The safety belt restraint system according to claim 16, wherein the airbag further comprise a partition wall arranged between the body section and the head section in the deployed state, where the partition wall has a gas passage formed therein.

23. The safety belt restraint system according to claim 16, wherein the head section of the airbag is configured to have a dimension in the Y-direction that is at least 20% greater than the maximum dimension of the body in the Y-direction when the airbag is in the deployed state.

24. The safety belt restraint system according to claim 16, wherein the body section of the airbag is configured to have an essentially tubular shape in the deployed state.

25. The safety belt restraint system according to claim 16 wherein the head section of the airbag is configured to have an essentially U-shape in a horizontal section.

26. The safety belt restraint system according to claim 16, wherein the head section of the airbag in the folded state is integrated into the safety belt on a side facing the seated occupant such that, after the deployment, the head section is at least partially arranged between the safety belt and the head of the seated occupant.

27. The safety belt restraint system according to claim 16, wherein the head section of the airbag in the folded state is integrated into the safety belt on a side of the safety belt facing away from the seated occupant such that, after the deployment, the head section is at least partially, arranged in front of the safety belt.

28. The safety belt restraint system according to claim 16, wherein the body section is completely integrated into the safety belt on a side of the safety belt facing the seated occupant such that, after the deployment, the body section is at least partially arranged between the safety belt and the torso of the seated occupant

29. The safety belt restraint system according to claim 16, wherein the body section is completely integrated into the safety belt on a side of the safety belt facing away from the seated occupant such that, after the deployment, the body section is at least partially, between of the safety belt and the seated occupant.

30. The safety belt restraint system according to claim 16, further comprising a gas generator and a gas line integrated into at least one of the safety belt, the fastening element, the belt buckle or a belt retractor for conveying gas from the gas generator into the airbag through the gas line.

31. The safety belt restraint system according to claim 16, wherein the safety belt comprises a shoulder belt and a lap belt configured to provide a three-point restraint.

32. A motor vehicle comprising:
a vehicle body supporting a front seat assembly and a rear seat assembly behind the front seat assembly; and
a safety belt restraint system for at least one of the front seat assembly or rear seat assembly, wherein the safety belt restraint system comprises a safety belt, a belt buckle fixed on the motor vehicle, a fastening element coupled to the safety belt and operable to releasably latch the safety belt to the belt buckle, and an airbag having a body section configured for a torso of the seated occupant and a head section airbag configured for a head of the seated occupant, wherein the airbag is integrated into the safety belt in a folded state and expandable into a deployed state out of the safety belt.
